(19) United States
(12) Patent Application Publication
(10) Pub. No.: US 2015/0054800 A1
(43) Pub. Date: Feb. 26, 2015

(54) METHOD AND APPARATUS FOR DRIVING DISPLAY AND PROVIDING PARTIAL DISPLAY

(71) Applicant: Samsung Electronics Co., Ltd., Gyeonggi-do (KR)

(72) Inventors: Dong-Hui KIM, Gyeonggi-do (KR); Dong-Sub Kim, Gyeonggi-do (KR); Sang-Yong EOM, Gyeonggi-do (KR)

(73) Assignee: Samsung Electronics Co., Ltd.

(21) Appl. No.: 14/469,293

(22) Filed: Aug. 26, 2014

(30) Foreign Application Priority Data
Aug. 26, 2013 (KR) 10-2013-0101050

(51) Int. Cl. G09G 3/36

(52) U.S. Cl. CPC G09G 3/3674
USPC 345/204

(57) ABSTRACT

An apparatus and a method for providing a partial display function related to a display device are provided. In a partial display mode, at least a part of operations of a display driver is inactivated in a non-display area of an entire display area of a display panel.

### PRIORITY

This application claims priority under 35 U.S.C. §119(a) to Korean Application Serial No. 10-2013-0101050, which was filed in the Korean Intellectual Property Office on Aug. 26, 2013, the entire content of which is incorporated herein by reference.

### BACKGROUND

1. Field of Invention

The present invention generally relates to an apparatus and a method for providing a partial display function related to a display device.

2. Description of the Related Art

A partial display function typically corresponds to methods for saving power of electronic devices using display devices. The partial display function may display an image only through a designated partial display area of a part of an entire display area of a display panel. Accordingly, it is possible to reduce power consumption of the display device when compared to displaying an image on the entire display area.

The partial display function may be used to reduce power consumption as much as possible while displaying monitoring information such as date and time, a message arrival, a call received, or the like when the user monitors the device when it is in a state where, for example, the electronic device is in a standby state.

For example, the partial display function may be implemented by displaying a black color in a non-display area of the entire display area. In another example, the partial display function may be implemented by turning off light-emission of pixels in a non-display area of the display device having self-light emitting pixels.

In general, a display driving apparatus used for driving a display panel performs a driving operation of an entire display area even when in a partial display mode. For example, in a display device having self-light emitting pixels, the display driving apparatus continues to perform the driving operation even in a non-display area to make pixels in the non-display area remain in an emission off state. Accordingly, power is continuously consumed due to the driving operation of the display driving apparatus in the non-display area in the partial display mode.

Further, when an electronic device displays a screen including a plurality of content items, the screen may display contents which a user does not want to view. In this case, the user is inconvenienced in selecting contents which the user desires, and also unnecessary power is consumed.

### SUMMARY

The present invention has been made to address the above problems and disadvantages, and to provide at least the advantages described below. Accordingly, an aspect of the present invention provides a display driving apparatus and method which can improve a power saving effect related to a partial display function.

Another aspect of the present invention provides a partial display apparatus and method which can perform a partial display to improve a power saving effect related to a partial display function.

In accordance with an aspect of the present invention, a display driving apparatus is provided. The display driving apparatus includes a display driver and a controller. The display driver drives a display panel according to input video data. The controller activates operations of the display driver in a partial display area designated in a part of an entire display area of the display panel and inactivates at least a part of the operations of the display driver in a non-display area other than the partial display area in a partial display mode.

In accordance with another aspect of the present invention, a display driving method is provided. The display driving method includes driving a normal display by performing display driving operations in an entire display area of a display panel when a normal display mode is set; and driving a partial display by performing the display driving operations in a partial display area designated in a part of the entire display area, and not performing at least a part of the display driving operations in a non-display area when a partial display mode is set.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram of a display driving apparatus according to an embodiment of the present invention;

FIG. 2 is a flowchart illustrating a process of display driving control according to an embodiment of the present invention;

FIGS. 3A and 3B are examples of screens for describing a comparison between a normal display and a partial display according to an embodiment of the present invention;

FIG. 4 is a block diagram of an electronic device according to an embodiment of the present invention;

FIG. 5 is a flowchart illustrating a partial display process according to an embodiment of the present invention; and

FIGS. 6A to 6D illustrate examples of screens for describing a partial display according to an embodiment of the present invention.

### DETAILED DESCRIPTION OF EMBODIMENTS OF THE PRESENT INVENTION

Hereinafter, embodiments of the present invention will be described in detail with reference to the accompanying drawings. The descriptions provided below using reference numerals for the accompanying drawings are to help comprehension of the embodiments of the present invention as being defined by the claims and their equivalents.

Furthermore, although various specific detailed descriptions are included to help comprehension of the embodiments of the present invention, these descriptions are to be considered illustrative only. Accordingly, it will be understood by those skilled in the art that various changes and modifications can be made without departing from the spirit and the scope of the present invention. Moreover, in describing the present invention, detailed descriptions related to well-known functions or configurations may be omitted.

The terms and words used in below descriptions and the claims are not limited to their dictionary meaning, and are to be used to help provide a clear and consistent comprehension of the present invention. Therefore, the definitions of the terms should be determined based on the contents throughout the specification.

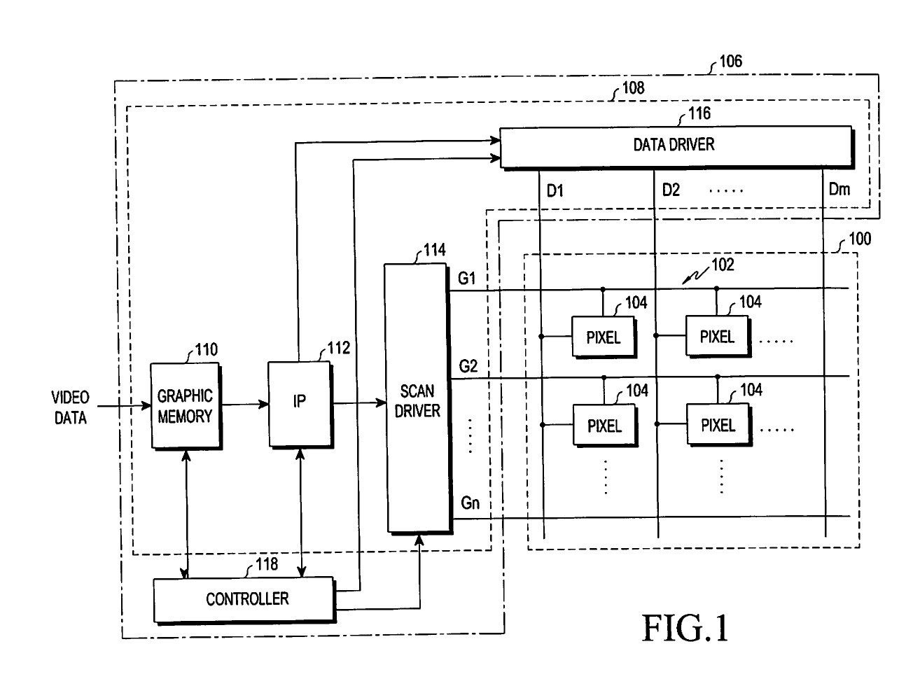

FIG. 1 is a block diagram of a display driving apparatus according to an embodiment of the present invention.

Referring to FIG. 1, a display driving apparatus 106 may be connected to a display panel 100 to drive the display panel 100. The display driving apparatus 106 may be implemented by an integrated circuit called a Display Drive Integrated Circuit (IC) (DDI), like a general display driving apparatus. The display panel 100 includes a pixel array 102 including a plurality of pixels 104. The pixel array 102 provides a display area used as a screen displaying an image. Respective pixels of the pixel array 102 may be independently driven by the display driving apparatus 106.

The display panel 100 may be a Liquid Crystal Display (LCD) such as a Thin Film Transistor-Liquid Crystal Display (TFT-LCD), or an Organic Light Emitting Diode (OLED) such as an Active Matrix Organic Light Emitting Diode (AMOLED). The display panel 100 may be a part of a touch screen display, which includes a display panel and a touch panel. The display panel and the touch panel may be integrally produced or separately produced and then assembled. The touch screen display displays an image according to an operation of the electronic device using the touch screen display on a screen and provides an input according to a contact on the screen by the user of the electronic device using the touch screen display. The user contact may be made by a contact input means such as a stylus or by a finger. The contact may include a hover made in proximity to the screen as well as a direct contact on the screen. The display panel 100 may be a stationary display panel or a flexible display panel.

The display driving apparatus 106 includes a display driver 108 and a controller 118. The display driver 108 drives the display panel 100 according to input video data. The video data may be input from the electronic device using the display panel 100. The electronic device using the display panel 100 may be, for example, a mobile phone, a smart phone, a navigation device, a game machine, a TeleVision (TV), a notebook computer, a tablet computer, a Personal Media Player (PMP), a Personal Digital Assistant (PDA) and the like. The display driving apparatus 106 may be included in the electronic device using the display panel 100.

The display driver 108 may include a graphic memory 110, an Image Processor (IP) 112, a scan driver 114, and a data driver 116. The graphic memory 110 buffers the video data input from the electronic device. The IP 112 processes the video data buffered by the graphic memory 110 to improve screen display quality of the video data, although the process of improving the screen display quality by the display driving apparatus 106 may not be required. In this case, the IP 112 may not be included in the display driver 108 and omitted. The scan driver 114 scans and drives scan lines G1 to Gn connected to the pixels 104 of the display panel 100. The scan driver 114 may sequentially select the scan lines G1 to Gn one by one and apply scan driving signals. In general, a driver such as the scan driver 114 is also called a gate driver. The data driver 116 drives data lines D1 to Dm connected to the pixels 104 of the display panel 100 in accordance with the video data processed by the IP 112. In general, a driver such as the data driver 116 is also called a source driver.

The display driving apparatus 106 may be set to one of a normal display mode and a partial display mode. The normal display mode refers to a display mode in which a full screen is displayed on an entire display area of the display panel 100. The partial display mode refers to a display mode in which a partial screen is displayed on a partial display area of the entire display area of the display panel 100.

The controller 118 controls an operation of the display driver 108 according to the display mode set to the display driving apparatus 106. The display panel 100 performs the normal display or the partial display according to the display mode set to the display driving apparatus 106.

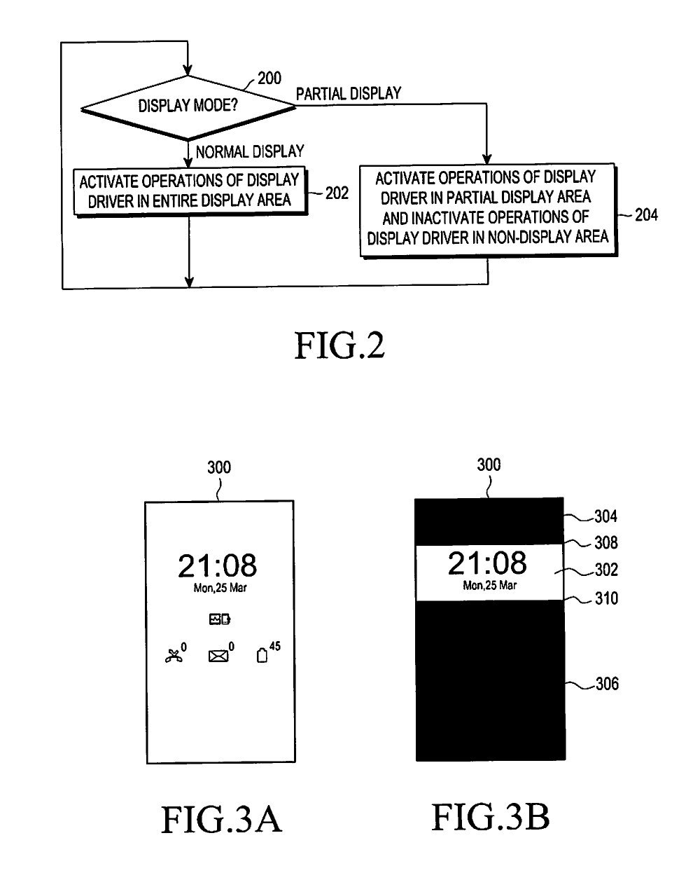

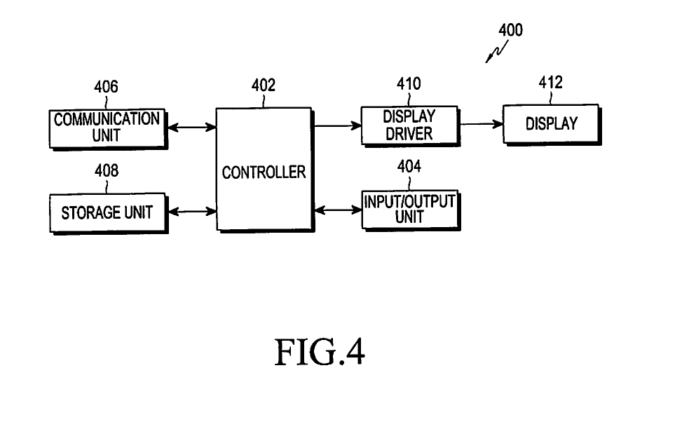

FIG. 2 is a flowchart illustrating a process of display driving control according to an embodiment of the present invention. FIGS. 3A and 3B are examples for describing comparison between the normal display and the partial display according to an embodiment of the present invention.

Referring to FIG. 2, the controller 118 identifies the display mode set to the display driving apparatus 106 in step 200, which is one of the normal display mode and the partial display mode set by the electronic device using the display panel 100.

The controller 118 may set a partial display on register or a normal display on register to set the display mode by the electronic device. When the normal display on register is set, the display driving apparatus 106 is set as the normal display mode. When the partial display on register is set, the display driving apparatus 106 is set as the partial display mode. When the display driving apparatus 106 is set as the partial display mode, a part of the entire display area of the display panel 100 may be designated as a partial display area by the electronic device, or one or more areas may be designated as the partial display area. The controller 118 may include a partial display area register for designating the partial display area by the electronic device.

When the display mode is identified as the normal display mode in step 200, the controller 118 performs the normal display mode in step 202. In step 202, the controller 118 activates the operation of the display driver 108 in the entire display area of the display panel. In this case, the video data buffering by the graphic memory 110, process of improving the screen display quality on video data by the IP 112, and the driving of the pixels 104 by the scan driver 114 and the data driver 116 may be performed in the entire display area. Accordingly, as shown in the example of FIG. 3A, the screen may be normally displayed through an entire display area 300 of the display panel 100.

When the display mode is identified as the partial display mode in step 200, the controller 118 performs the partial display mode in step 204. In step 204, the controller 118 activates the operation of the display driver 108 in the partial display area designated in the part of the entire display area of the display panel 100 and inactivates the operation of the display driver 108 in the non-display area other than the partial display area. In this case, the display driver 108 performs the display driving operation in the partial display area, but does not perform the display driving operation in the non-display area. The graphic memory 110 buffers only video data corresponding to the partial display area. The IP 112 processes only the video data corresponding to the partial display area to improve the screen display quality. The scan driver 114 drives only scan lines corresponding to the partial display area among the scan lines G1 to Gn connected to the pixels 104 of the display panel 100. The data driver 116 drives only data lines corresponding to the partial display area among the data lines D1 to Dm connected to the pixels 104 of the display panel 100. Accordingly, as shown in the example of FIG. 3B, the screen is displayed through the partial display area 302 which is the part of the entire display area 300 and the screen is not displayed on non-display areas 304 and 306.

The partial display area may be designated in various forms such as a vertical form or a window form as well as a horizontal form like the partial display area 302 illustrated in FIG. 3B. When the partial display area 302 is designated as illustrated in FIG. 3B, a start row 308 and an end row 310 of the partial display area 302 may be set to a partial display area register of the controller 118 by the electronic device.

As described above, the display driving apparatus 106 does not perform the driving operation in the remaining non-display area except for the partial display area in the entire display area of the display panel 100 in the partial display mode. Accordingly, in the non-display area, power required for the operation of the graphic memory 110, the IP 112, the scan driver 114, and the data driver 116 in the non-display area is not consumed. Therefore, a power reduction effect can be increased.

In another embodiment of the present invention, only a partial operation of the display driver 108 may be inactivated instead of inactivating all operations of the display driver 108 in the non-display area in the partial display mode. For example, the controller may activate only the operations of some of the graphic memory 110, the IP 112, the scan driver 114, and the data driver 116 in the non-display area. In this case, the power reduction effect is decreased in comparison with a case where the all operations of the display driver 108 are inactivated in the non-display area, but the power reduction effect is increased in comparison with a case where the display driver 108 performs the driving operation in the entire display area.

According to embodiments of the present invention, it is possible to reduce power consumption by inactivating at least a part of operations of a display driving apparatus in a non-display area in a partial display mode and thus improve a power saving effect.

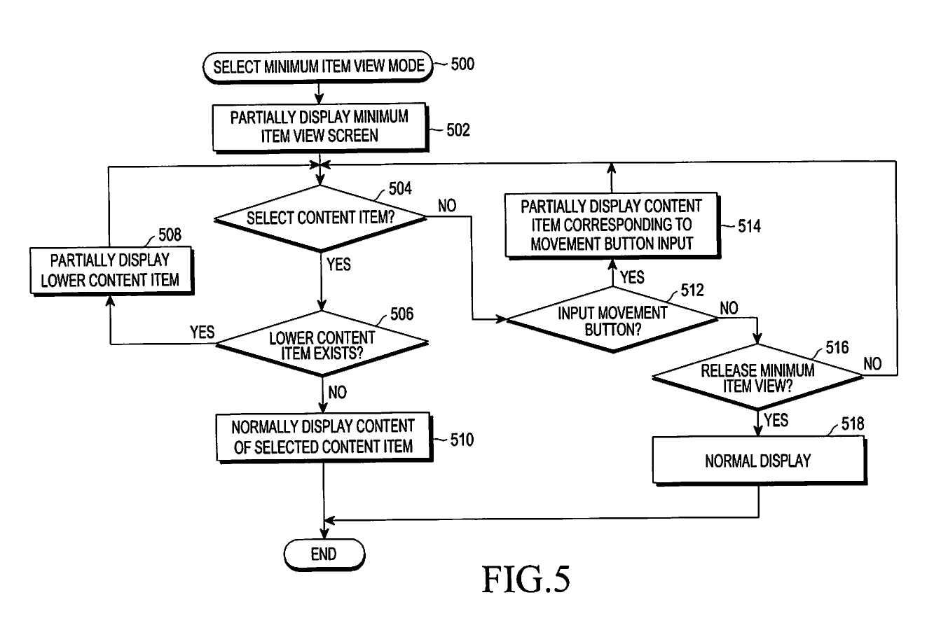

FIG. 4 is a block diagram of an electronic device 400 according to an embodiment of the present invention.

Referring to FIG. 4, the electronic device 400 includes a controller 402, an input/output unit 404, a communication unit 406, a storage unit 408, a display driver 410, and a display 412. The electronic device 400 may be a mobile phone, a smart phone, a navigation device, a game machine, a TV, a notebook computer, a tablet computer, a PMP, a PDA or the like.

The controller 402 controls the input/output unit 404, the communication unit 406, the storage unit 408, the display driver 410, and the display 412.

The input/output unit 404 may include a plurality of buttons, a microphone, a speaker, a vibration motor, a connector, a keypad, a mouse, a trackball, a joystick, cursor direction keys, or a cursor control which receives a user input or informs the user of information. The buttons may include a power/lock button, a volume button, a menu button, a home button, a back button, or a search button. The microphone receives a voice or sound and generates an electrical signal according to a control of the controller 402. The speaker outputs sounds corresponding to various signals (for example, a wireless signal, a broadcasting signal, a digital audio file, a digital video file, capturing a picture, or the like) to the outside of the electronic device 400 according to a control of the controller 402. The speaker also outputs a sound corresponding to a function performed by the electronic device 400. The vibration motor converts an electrical signal into a mechanical vibration according to a control of the controller 402. For example, when the electronic device 400 in a vibration mode receives a voice call, the vibration motor may be operated. The vibration motor may operate in response to a contact on the display 412 by the user. The connector is used as an interface for connecting the electronic device 400 with a server, an external electronic device, or a power source. The connector transmits/receives data stored in the storage unit 408 of the electronic device 400 to/from an external device through a wired cable connected to the connector according to a control of the controller 402. Through the wired cable connected to the connector, electric power can be fed from the power source or a battery can be charged. The keypad receives a key input from a user for a control of the electronic device 400. The keypad may include a physical keypad included in the electronic device 400, or a virtual keypad display on the display unit 412.

The communication unit 406 may be provided for a direct connection with a server or an external electronic device or a connection through the network and may be a wired or wireless communication unit.

The storage unit 408 stores a program for the operation of the controller 402 and stores various types of data according to the operation of the controller 402. The storage unit 408 may further include an external memory and also a storage device such as a Hard Disk Drive (HDD).

The display 412 displays a screen according to the operation of the electronic device 400. The display 412 may include a touch panel. The display driver 410 drives the display 412 under a control of the controller 402. The display driver 410 is a display driving apparatus which can operate in the partial display mode. The display driver 400 may be, for example, the display driving apparatus 106, but is not limited thereto.

In a minimum item view mode, the controller 402 partially displays a content item selected in the screen including a plurality of content items by controlling the display driver 410.

An electronic device, such as the electronic device 400, using the display device displays a screen including a plurality of content items. For example, when the electronic device 400 accesses an Internet portal site and displays a webpage, the webpage may include a plurality of contents. The contents may include a contents such as an advertisement, a news headline, and the like which the user may not want to view. When the contents which the user does not want to view are displayed, the user must select only contents which the user wants, and unnecessary power is consumed.

According to an embodiment of the present invention, the electronic device 400 provides the minimum item view mode which allows the user to easily select contents which the user wants, and prevents unnecessary power consumption using the partial display function.

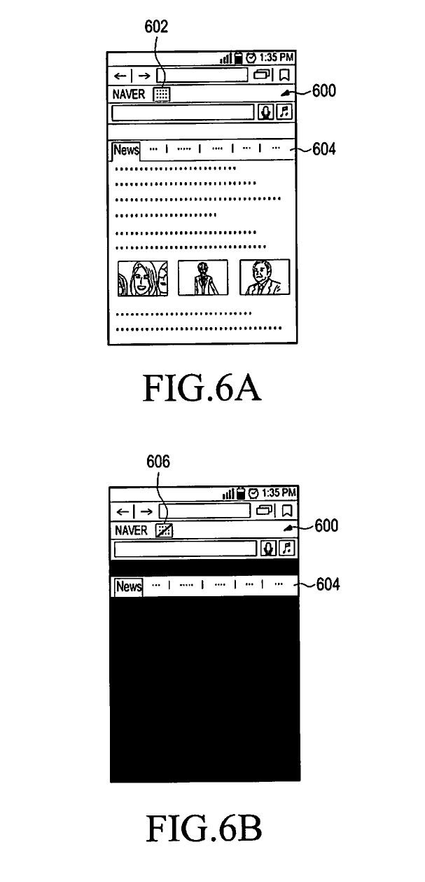

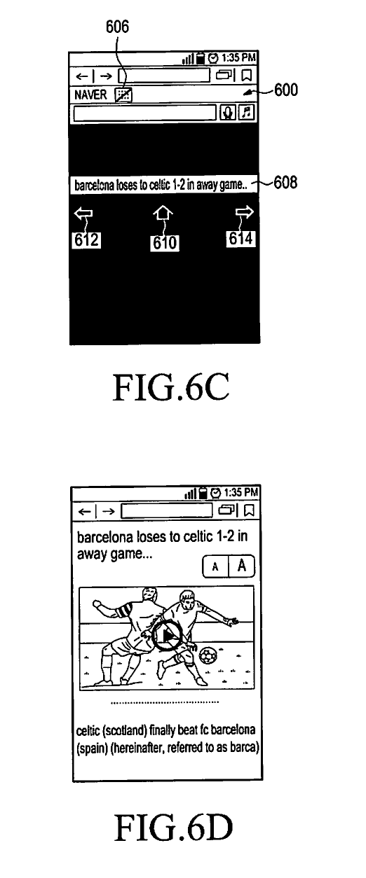

FIG. 5 is a flowchart illustrating a partial display process according to an embodiment of the present invention. FIGS. 6A to 6D illustrate examples of screens for describing a partial display according to an embodiment of the present invention.

When the electronic device 400 accesses an Internet portal site and displays a webpage as described in the example of FIG. 6A, a basic window 600 related to a web browser and the webpage and content items 604 provided by the Internet portal site are displayed. In this case, the electronic device 400 may display a minimum item view icon 602 within the screen as illustrated in FIG. 6A. When the minimum item view icon 602 is clicked by the user, the minimum item view mode may is selected.

When the user selects the minimum item view mode in step 500 of FIG. 5, the controller 402 partially displays a minimum item view screen as illustrated in FIG. 6B in step 502. FIG. 6B illustrates that only main content items 604 are partially displayed on the screen of FIG. 6B. When the partial display is made as described above, the controller 402 displays a minimum item view release icon 606 within the screen as illustrated in FIG. 6B instead of the minimum item view icon 602. When the minimum item view release icon 606 is clicked by the user, the minimum item view mode is released.

The controller 402 determines whether to select a content item while performing the partial display as illustrated in FIG. 6B in step 504. When the content item is selected, the controller 402 determines whether a lower content item exists in step 506. When the lower content item exists, the controller 402 partially displays the lower content item in step 508 and returns to step 504. For example, when a “News” item is selected from the content items illustrated in FIG. 6B in step 504, the controller 402 displays a lower content item 608 of the “News” item as illustrated in FIG. 6C in step 508. In this case, the controller 402 may display a home button 610 and movement buttons 612 and 614 on the screen. The home button 610 may be clicked by the user and used to move to the main screen illustrated in FIG. 6B.

When the content item is not selected in step 504, the controller 402 determines whether a movement button is input in step 512. When one of the movement buttons 612 and 614 is input in step 512, the controller 402 moves to a content item corresponding to the movement button input to partially display the moved content item in step 514 and returns to step 504.

When the lower content item of the selected content item does not exist in step 506 like the content item 608 illustrated in FIG. 6C, the controller 402 moves to step 510 from step 506 to terminate the minimum item view mode and normally display the content of the selected content item as illustrated in FIG. 6D.

When there is no movement button input in step 512, the controller 402 determines whether the minimum item view mode is released in step 516. When the minimum item view mode is not released, the controller 402 returns to step 504. When the minimum item view release icon 606 is clicked by the user, the controller 402 moves to step 518 from step 516 to release the minimum item view mode and return to the normal display as illustrated in FIG. 6A.

In another embodiment of the present invention, the minimum item view mode may be selected by a proximity touch type generally referred to as hovering, as well as by clicking the minimum item view icon 602. For example, when a proximity touch is made on one of the content items by the user, the minimum item view mode is selected, and thus the proximity-touched content item is partially displayed.

As described above, in the minimum item view mode, only main content items or content items which the user selects are partially displayed and the remaining contents are not displayed, so that the user can easily select contents which the user desires, and prevent unnecessary power consumption.

According to embodiments of the present invention, it is possible to reduce power consumption caused by a display of unnecessary contents by partially displaying a content item selected in a screen including a plurality of content items, and thus to improve a power saving effect.

According to embodiments of the present invention, the electronic device downloads a program (for example, an application) for performing the display driving or partial display from a program providing apparatus (for example, a server) remotely located and executes the downloaded program, so as to use the program for performing the display driving or partial display. The program providing apparatus may transmit the program to the electronic device in response to a request for the program, or automatically. In this case, the program providing apparatus may additionally perform service subscription determination, user authentication, and payment information verification for the electronic device. The program providing apparatus may include a communication unit for performing wired or wireless communication with the electronic device through, a storage medium for storing the program, and a controller for transmitting the program to the electronic device through the communication unit. The storage medium may be located inside or outside the program providing apparatus.

Further, a display driving method or a partial display method according to embodiments of the present invention can be implemented in the form of hardware, software, or a combination thereof. The software can be stored in, for example, irrespective of being erasable or rewritable, a volatile or a non-volatile storage device such as a read only memory (ROM) and, random access memory (RAM), or an optically or magnetically recordable and machine readable storage medium such as a compact disk (CD), a digital versatile disc (DVD), a magnetic disk, and a magnetic tape. Accordingly, the present disclosure includes a program for a code implementing the apparatus and method defined in the appended claims of this specification and a machine (a computer or the like)-readable storage medium for storing the program. Furthermore, such a program may be electronically transferred through an arbitrary medium such as a communication signal transferred through a wired or wireless connection, and the present invention may appropriately include equivalents thereof.

Accordingly, the scope of the present invention should not be limited or determined by the described embodiments, and should be determined by the accompanying claims and the equivalents thereof.

What is claimed is:

1. A display driving apparatus comprising:
a display driver configured to drive a display panel according to input video data; and
a controller configured to activate operations of the display driver in a partial display area designated in a part of an entire display area of the display panel, and to inactivate at least a part of the operations of the display driver in a non-display area other than the partial display area in a partial display mode.

2. The display driving apparatus of claim 1, wherein the display driver comprises:
a graphic memory configured to buffer the video data;
a scan driver configured to scan and drive scan lines connected to pixels of the display panel; and
a data driver configured to drive data lines connected to the pixels in accordance with the video data buffered by the graphic memory,
wherein the controller is configured to inactivate an operation of at least one of the graphic memory, the scan driver, and the data driver in the non-display area.

3. The display driving apparatus of claim 1, wherein the display driver comprises:
a graphic memory configured to buffer the video data;
an image processor configured to process the video data buffered by the graphic memory to improve a screen display quality of the video data;
a scan driver configured to scan and drive scan lines connected to pixels of the display panel; and
a data driver configured to drive data lines connected to the pixels in accordance with the video data processed by the image processor,
wherein the controller is configured to inactivate an operation of at least one of the graphic memory, the image processor, the scan driver, and the data driver in the non-display area.

4. A display driving method of driving a display by a display driving apparatus, the method comprising:
driving a normal display by performing display driving operations in an entire display area of a display panel when a normal display mode is set; and
driving a partial display by performing the display driving operations in a partial display area designated in a part of the entire display area, and not performing at least a part of the display driving operations in a non-display area when a partial display mode is set.

5. The display driving method of claim 4, wherein driving the partial display comprises buffering only video data corresponding to the partial display area.

6. The display driving method of claim 4, wherein driving the partial display comprises processing to improve a screen display quality only for video data corresponding to the partial display area.

7. The display driving method of claim 4, wherein driving the partial display comprises driving only scan lines corresponding to the partial display area among scan lines connected to pixels of the display panel.

8. The display driving method of claim 4, wherein driving the partial display comprises driving only data lines corresponding to the partial display area among data lines connected to pixels of the display panel.
